(19) United States
(12) Patent Application Publication
(10) Pub. No.: US 2007/0012127 A1
(43) Pub. Date: Jan. 18, 2007

(54) Anti-backlash nut assembly for a lead screw

(76) Inventor: Frank Morton, Harwinton, CT (US)

Correspondence Address: JOHN H CROZIER, 1934 HUNTINGTON TURNPIKE, TRUMBULL, CT, 06611, US

(21) Appl. No.: 10/574,118

(22) PCT Filed: Jun. 10, 2004
(86) PCT No.: PCT/US04/18364

§ 371 Date: Mar. 30, 2006

Related U.S. Application Data
(60) Provisional application No. 60/506,752, filed on Sep. 30, 2003.

(51) Int. Cl. F16H 25/20

(52) U.S. Cl. 74/89.42

(57) ABSTRACT

In a preferred embodiment, a system, including: an anti-backlash nut having a tapered surface at one end thereof; a drive nut having a complementary tapered surface engaging the tapered surface on the anti-backlash nut; and biasing means urging the tapered surfaces together. A method is also provided.

### TECHNICAL FIELD

The present invention relates to leadscrews generally and, more particularly, but not by way of limitation, to a novel anti-backlash nut for a leadscrew.

### BACKGROUND ART

Many modern linear devices require very precise movement. Systems that employ a leadscrew/nut configuration will exhibit some backlash between the two elements. Assemblies to eliminate this backlash can be complex and difficult to manufacture.

A common method to load two nut assemblies onto the leadscrew and force them apart by means of a spring or the like. This creates excess added drag on the system and offers a limited “zone” of anti-backlash, meaning the spring must be matched for the load. Some systems employ a torsion spring to load the two nut assemblies against each other. This helps to reduce the matching of the spring to the load that was required with the first system described. These torsion systems employ a collar to capture the two nut halves or a friction disk between the two nut halves. This is an additional part that can be eliminated.

Accordingly, it is a principal object of the present invention to provide an anti-backlash nut assembly that eliminates the additional part.

It is another object of the invention to provide such an antibacklash nut assembly that consists of two or three parts.

It is a further object of the invention to provide such an antibacklash nut assembly that is tolerant of various assembly torques.

It is an additional object of the invention to provide such an antibacklash nut assembly that is quick and easy to assemble.

It is yet another object of the invention to provide such an anti-backlash nut assembly that is compact in size and can thus be fit inside the rotor bushing of a linear actuator.

Other objects of the present invention, as well as particular features, elements, and advantages thereof, will be elucidated in, or be apparent from, the following description and the accompanying drawing figures.

### DISCLOSURE OF INVENTION

The present invention achieves the above objects, among others, by providing, in a preferred embodiment, a system, comprising: an anti-backlash nut having a tapered surface at one end thereof; a drive nut having a complementary tapered surface engaging said tapered surface on said anti-backlash nut; and biasing means urging said tapered surfaces together. A method is also provided.

### BRIEF DESCRIPTION OF DRAWINGS

Understanding of the present invention and the various aspects thereof will be facilitated by reference to the accompanying drawing figures, provided for purposes of illustration only and not intended to define the scope of the invention, on which:

FIG. 1 is a side elevational view, in cross-section, of one embodiment of the present invention.

FIG. 2 is a side elevational view, in cross-section, of another embodiment of the present invention.

FIG. 3 is a side elevational view, in cross-section, of a further embodiment of the present invention.

FIGS. 4 and 5 are isometric views of alternative arrangements of spring anchoring means.

### BEST MODE FOR CARRYING OUT THE INVENTION

Reference should now be made to the drawing figures on which similar or identical elements are given consistent identifying numerals throughout the various figures thereof, and on which parenthetical references to figure numbers, when used, direct the reader to the view(s) on which the element(s) being described is (are) best seen, although the element(s) may be seen on other figures also.

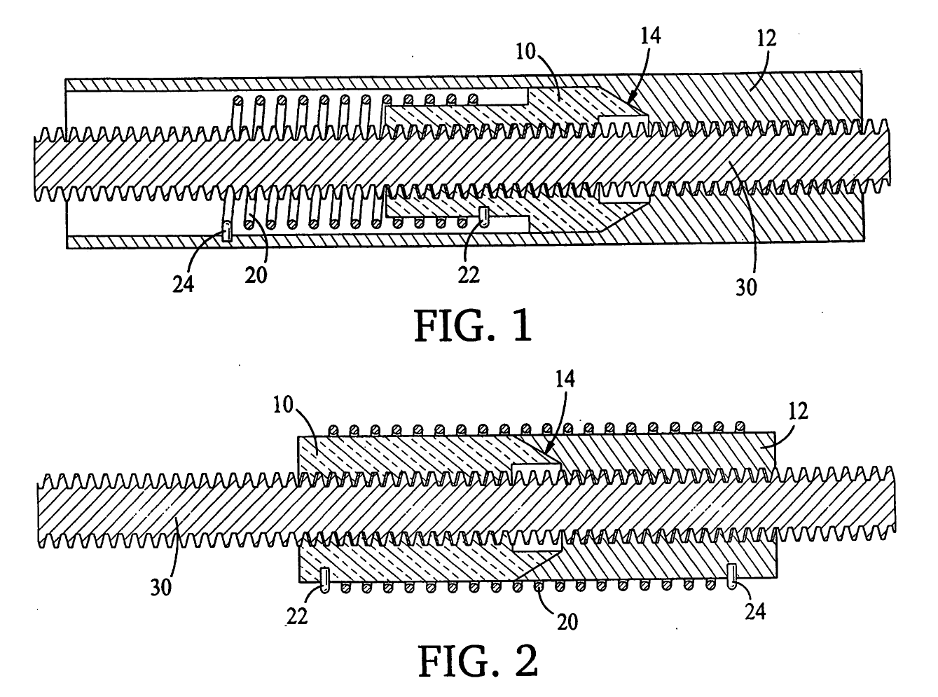

FIG. 1 illustrates one embodiment of the present invention. Here, two nut assemblies 10 (antibacklash) and 12 (drive) are made with complementary shallow angles 14 formed at their distal ends where they meet. Nuts 10 and 12 are held in position relative to each other by means of a torsion spring 20 attached, by suitable means, to the nuts at 22 and 24, respectively, such as by inserting ends of the spring into channels formed in the nuts. The angle of interface 14 can vary, but approximately 30° from horizontal yields good results and provides the friction to keep them aligned with each other. Torsion spring 20 may also be stretched to a desirable degree to provide a higher friction force. As nuts 10 and 12 are threaded together on a lead screw 30, the faces thereof push against each other and load the nut threads against the thread of the leadscrew in opposing directions.

In assembly, one of nuts 10 and 12 is threaded onto leadscrew 30. Then the other of nuts 10 and 12 is threaded onto the leadscrew, with the tapers facing each other. Next, torsion spring 20 is securely attached to one of nuts 10 and 12 and is “wound up” to create a load and then is securely attached to the other of the nuts. This keeps threaded nuts 10 and 12 in position relative to each other. The friction of the tapered surfaces on nuts 10 and 12 keeps the nuts from moving relative to each other.

This mechanism is also adjustable in that torsion spring 20 can be turned more (wound up more) to create a higher preload force. There may be multiple holes defined around the outsides of nuts 10 and 12 where ends of torsion spring 20 can be captured.

There are other embodiments of this device where one nut may extend around the outside diameter of the torsion spring and have the torsion spring attached to the opposite end of the housing. This provides a torsion load by the torsion spring as well as a slight compression load to increase the friction force on the tapered surfaces of the nuts. By biasing the two nut portions against the leadscrew threads, the backlash in the threads is removed. This assembly, by virtue of being preloaded with the spring will also compensate for wear of the nut and leadscrew interface.

FIG. 2 illustrates another embodiment of the present invention. Here, as was the case with the embodiment shown on FIG. 1, nuts 10 and 12 are threaded onto a lead screw 30 and their distal ends meet at an interface 14. In this case, spring 20 is wound on the outside of nuts 10 and 12 and the ends thereof are anchored in the nuts at 22 and 24, respectively. The action of spring 20 in this case is the same as described with reference to FIG. 1, except that the spring extends over nut 12, as well as over nut 10.

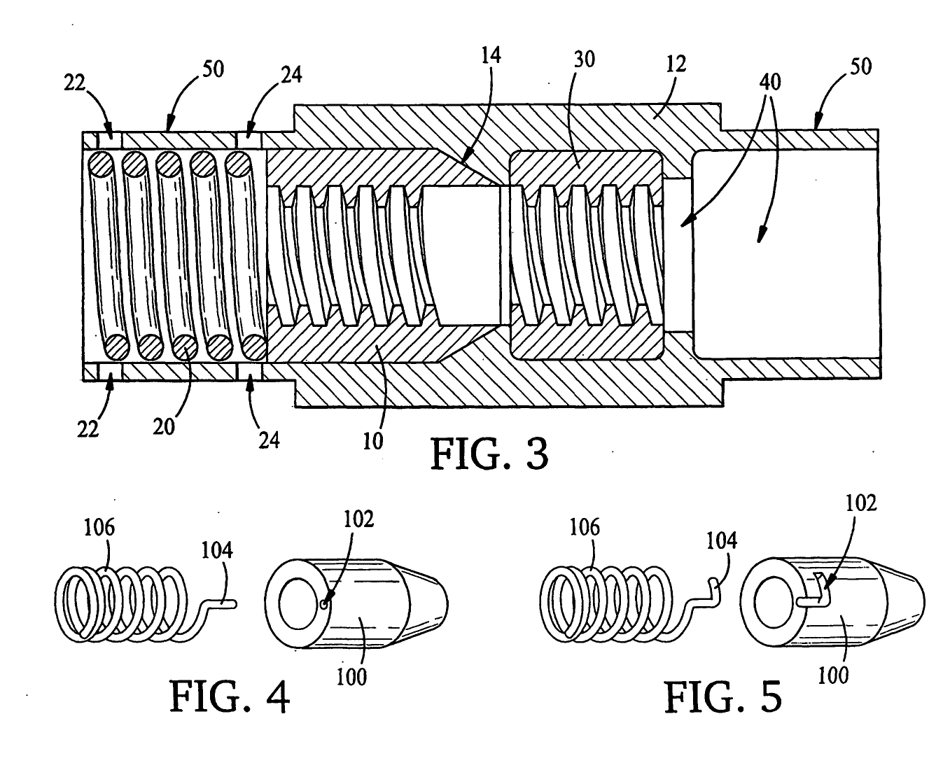

FIG. 3 illustrates a further embodiment of the present invention, shown without a lead screw. A torsion spring 20 abuts the back of anti-backlash nut 10 and can be molded into the antibacklash nut or it may be adhesively attached thereto. Antibacklash nut 10 meets drive nut 12 at interface 14. Openings 22 and 24 are provided for anchoring torsion spring 20, if the torsion spring is not adhesively attached to antibacklash nut 10. A thermoplastic main drive nut 30 may be molded into metallic drive nut 12. Spaces 40 are provided at one end of drive nut 12 to accommodate one end of a lead screw (not shown). Bearing journals 50 are provided on the exterior surface of drive nut 12.

FIG. 4 illustrates one method of anchoring a spring. Here, an antibacklash nut 100 has defined in one end thereof an opening 102 for the insertion therein of an end 104 of a torsion spring 106.

FIG. 5 illustrates another method of anchoring a spring. Here, an antibacklash nut 100 has defined therein an L-shaped opening 102 to accommodate therein the insertion of an end 104 of a torsion spring 106. The ID of the rotor bushing (not shown) keeps spring 106 from disengaging and the L-shaped opening 102 secures spring 106 axially.

In the cases shown on FIGS. 4 and 5, the spring is separate, thus eliminating having to mold the spring into the antibacklash nut and the assembly consists of three parts—the rotor bushing with main drive nut, the antibacklash nut, and a torsion spring. In either case, the end of spring 106 may be anchored using either of the techniques shown.

In the embodiments of the present invention described above, it will be recognized that individual elements and/or features thereof are not necessarily limited to a particular embodiment but, where applicable, are interchangeable and can be used in any selected embodiment even though such may not be specifically shown.

Spatially orienting terms such as “above”, “below”, “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

1. A system, comprising:
(a) an anti-backlash nut having a tapered surface at one end thereof;
(b) a drive nut having a complementary tapered surface engaging said tapered surface on said anti-backlash nut; and
(c) biasing means urging said tapered surfaces together.

2. A system, as defined in claim 1, wherein: said tapered surface on said anti-backlash nut is about 30 degrees from horizontal.

3. A system, as defined in claim 1, wherein: said biasing means surrounds at least a portion of said anti-backlash nut.

4. A system, as defined in claim 1, wherein: said biasing means surrounds at least portions of said anti-backlash nut and said drive nut.

5. A system, as defined in claim 1, wherein: said biasing means abuts a surface of said anti-backlash nut opposite said tapered surface.

6. A system, as defined in claim 5, wherein: said biasing means is molded into said anti-backlash nut.

7. A system, as defined in claim 5, wherein: said biasing means is adhesively attached to said anti-backlash nut.

8. A system, as defined in claim 1, wherein: said drive nut is metallic and has a thermoplastic main drive nut molded thereinto.

9. A system, as defined in claim 1, wherein: said anti-backlash and said drive nuts are internally threaded and have 1. A system, comprising:
(a) an anti-backlash nut having a tapered surface at one end thereof;
(b) a drive nut having a complementary tapered surface engaging said tapered surface on said anti-backlash nut; and
(c) biasing means urging said tapered surfaces together.

10. A system, as defined in claim 1, wherein: said biasing means is a torsion spring.

11. A system, as defined in claim 10 wherein: at least one end of said torsion spring is inserted into a hole defined axially in said anti-backlash nut.

12. A system, as defined in claim 10, wherein: at least one end of said torsion spring is inserted into a channel defined in an outer periphery of said anti-backlash nut.

13. A method of providing a system, comprising:
(a) providing an anti-backlash nut having a tapered surface at one end thereof;
(b) providing a drive nut having a complementary tapered surface engaging said tapered surface on said anti-backlash nut; and
(c) providing biasing means urging said tapered surfaces together.

14. A method of providing a system, as defined in claim 13, further comprising: providing said tapered surface on said anti-backlash nut about 30 degrees from horizontal.

15. A method of providing a system, as defined in claim 13, further comprising: providing said biasing means surrounding at least a portion of said anti-backlash nut.

16. A method of providing a system, as defined in claim 13, further comprising: providing said biasing means surrounding at least portions of said anti-backlash nut and said drive nut.

17. A method of providing a system, as defined in claim 13, further comprising: providing said biasing means abutting a surface of said anti-backlash nut opposite said tapered surface.

18. A method of providing a system, as defined in claim 17, further comprising: providing said biasing means molded into said anti-backlash nut.

19. A method of providing a system, as defined in claim 17, further comprising: providing said biasing means adhesively attached to said anti-backlash nut.

20. A method of providing a system, as defined in claim 13, further comprising: providing said drive nut as metallic and having a thermoplastic main drive nut molded thereinto.

21. A method of providing a system, as defined in claim 13, further comprising: providing said anti-backlash and said drive nuts internally threaded and having axial openings therethrough to accommodate a lead screw.

22. A method of providing a system, as defined in claim 13, further comprising: providing said biasing means as a torsion spring.

23. A method of providing a system, as defined in claim 22, further comprising: providing at least one end of said torsion spring inserted into a hole defined axially in said anti-backlash nut.

24. A method of providing a system, as defined in claim 22, further comprising: providing at least one end of said torsion spring inserted into a channel defined in an outer periphery of said anti-backlash nut.
